(19) United States
(12) Patent Application Publication
(10) Pub. No.: US 2016/0147826 A1
(43) Pub. Date: May 26, 2016

(54) METHOD AND APPARATUS FOR UPDATING POINTS OF INTEREST INFORMATION VIA CROWDSOURCING

(71) Applicant: NOKIA TECHNOLOGIES OY, Espoo (FI)

(72) Inventor: Pranav MISHRA, Bangalore (IN)

(21) Appl. No.: 14/904,201

(22) PCT Filed: Jun. 25, 2014
(86) PCT No.: PCT/FI2014/050510

§ 371 Date: Jan. 11, 2016

(30) Foreign Application Priority Data
Jul. 18, 2013 (IN) 3213/CHE/2013

(51) Int. Cl. G06F 17/30

(52) U.S. Cl. CPC G06F 17/30377; G06F 17/3087

(57) ABSTRACT

An approach is provided for updating or validating information associated with potential points of interest using crowd sourcing methods. The validation/updating platform determines at least one query from at least one device for location information associated with at least one point of interest. Next, the validation/updating platform determines at least one next location visited by the at least one device. Then, the validation/updating platform causes, at least in part, an updating of the location information associated with the at least one point of interest based, at least in part, on the at least one next location.

### BACKGROUND

Service providers and device manufacturers (e.g., wireless, cellular, etc.) are continually challenged to deliver value and convenience to consumers by, for example, providing compelling network services. One area of interest has been service providers providing various services to users and their devices; for example, search engines, driving/map/routing information, information on various points of interest (POI, POIs) based on user enquiries or user/device location, or the like. In one scenario, a service provider may access various databases to determine and provide the requested information/service. For example, a service provider may utilize various databases to determine and provide information in response to a POI enquiry from a user device, or the service provider may utilize Global Positioning System (GPS) location information of the user device to determine and suggest various POIs to a user at a user device. Nevertheless, in order to determine and provide accurate information/services, the service providers need to have access to accurate and updated information/databases. However, the updating process may be challenging as it may require large scale resources and efforts to address fast changing information (e.g., in developing regions), or that the updates may be slow or unverified (e.g., many databases for many regions). As such, service providers and device manufacturers face significant technical challenges in maintaining and accessing up-to-date, accurate, and reliable information for use in providing services or when responding to enquiries.

### SOME EXAMPLE EMBODIMENTS

Therefore, there is a need for an approach for updating or validating information associated with potential points of interest using crowd sourcing methods.

According to one embodiment, a method comprises determining at least one query from at least one device for location information associated with at least one point of interest. The method also comprises determining at least one next location visited by the at least one device. The method further comprises causing, at least in part, an updating of the location information associated with the at least one point of interest based, at least in part, on the at least one next location.

According to another embodiment, an apparatus comprises at least one processor, and at least one memory including computer program code for one or more computer programs, the at least one memory and the computer program code configured to, with the at least one processor, cause, at least in part, the apparatus to determine at least one query from at least one device for location information associated with at least one point of interest. The apparatus is also caused to determine at least one next location visited by the at least one device. The apparatus is further caused to cause, at least in part, an updating of the location information associated with the at least one point of interest based, at least in part, on the at least one next location.

According to another embodiment, a computer-readable storage medium carries one or more sequences of one or more instructions which, when executed by one or more processors, cause, at least in part, an apparatus to determine at least one query from at least one device for location information associated with at least one point of interest. The apparatus is also caused to determine at least one next location visited by the at least one device. The apparatus is further caused to cause, at least in part, an updating of the location information associated with the at least one point of interest based, at least in part, on the at least one next location.

According to another embodiment, an apparatus comprises means for determining at least one query from at least one device for location information associated with at least one point of interest. The apparatus also comprises means for determining at least one next location visited by the at least one device. The apparatus further comprises means for causing, at least in part, an updating of the location information associated with the at least one point of interest based, at least in part, on the at least one next location.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of updating or validating information associated with potential points of interest using crowd sourcing methods, according to an embodiment;

FIG. 2 is a diagram of the components of a user equipment capable of receiving information and submitting crowdsourcing information, according to an embodiment;

FIG. 3 is a diagram of the components of an updating platform, according to an embodiment;

FIGS. 4 through 6 illustrate flowcharts of various processes for, at least, updating or validating information associated with potential points of interest using crowd sourcing methods, according to various embodiments;

FIG. 7A illustrates flow diagrams of various scenarios for identifying information to be verified and updated, according to an embodiment;

FIG. 7B illustrates presentations of location information of various points of interest, according to an example;

FIGS. 8A through 8C are diagrams of user interfaces utilized in processes in the FIGS. 4-6 and 7A, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for updating or validating information associated with potential points of interest using crowd sourcing methods are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. Although verification, validation, and updating processes are discussed with reference to location information associated with points of interest, other information types (e.g., images, comments, etc.) also may be determined, verified, validated, and updated.

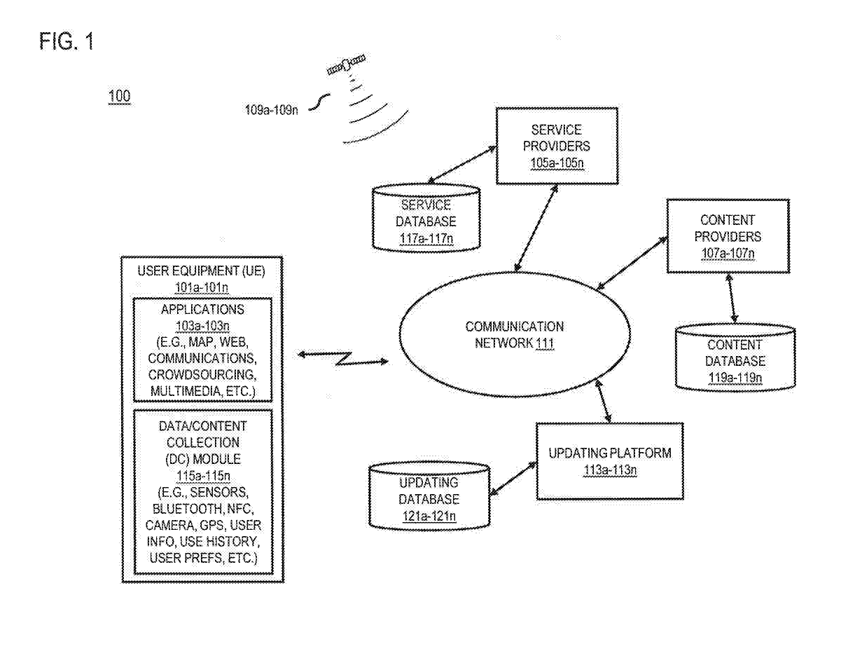

FIG. 1 is a diagram of a system capable of updating or validating information associated with potential points of interest using crowd sourcing methods, according to one embodiment. As discussed, recent technological advances create widespread uses of location-based services (e.g., mapping services, search engines, etc.), where service providers may utilize various information associated with various POIs, geo-locations, and the like, to provide those services. In order to accurately provide those services, the service providers need to have access to updated and accurate information and databases, which may be created, maintained, or updated by those service providers and/or by various third-party service/content providers. However, the information associated with the POIs or the geo-locations may change frequently, especially in developing areas, where the changes may be due to changes to existing POIs or addition of new POIs. For example, in new market economies, new urban areas may quickly develop with new POIs such as restaurants, theaters, schools, banking offices, etc., where the location information of these new POIs may not be available to the service/content providers for some time. Traditionally, content and service providers may utilize their own or third party services to obtain the new information and accordingly update their databases; however, the included tasks may require additional resources, time, financing, organization, validation of the changes, etc. Additionally, timely updates can be critical in accurately providing the contents or services so the content or service providers can retain users or add new users to their client base. Now, with the multitude of user devices and applications in use at different geo-locations, the content and service providers may be able to recruit and utilize those devices/applications to update and validate the changing information associated with the POIs and the geo-locations.

To address this problem, a system 100 of FIG. 1 introduces the capability for updating or validating information associated with potential points of interest using crowd sourcing methods. For example, POIs or their associated information may continually change or increase, especially in a developing area. The system 100 may provide a mechanism to ensure that potential POIs and their related information are accurate, and once they are validated to a certain degree of accuracy, then various content or service providers in the system 100 may upload and utilize the validated information in providing contents and services to their users.

In one use case scenario, a service provider may receive a query/search request from a user/device for information on a certain POI and the results to that search request indicate that the POI cannot be identified, or that there are no information associated with the POI, or that there may be some unverified information associated with the POI. For example, a service provider may receive a request from a user for navigation directions to a new restaurant that cannot be identified by the service provider (e.g., a missing POI), hence, the service provider may not be able to present the requested navigation directions to the user. However, the service provider may utilize various methods for verifying and updating the information related to the unverified or missing POI.

In one scenario, after a service provider determines that a search result indicates that there is a missing POI, then the service provider may monitor location information of the device that requested location information on the missing POI and determine where the next location of the device is. For instance, the service provider receives a request from a user device for information on a certain POI, the service provider cannot find the requested information, then the service provider monitors and determines the location that the user device visits next. In one example, a user may request driving direction to Joe's Burgers, the service provider cannot find location information for Joe's Burgers, and the user drives/travels to a next location. In one scenario, the next location that the user drives to may be indeed the location of Joe's Burgers, which the user may have determined by other means (e.g., called a friend). In one scenario, the service provider may utilize the location information of the next location and associate that location information with Joe's Burgers. In one embodiment, the service provider may determine location information of the user/device along a route from the user's current location to the users next location so that various potential location information may be determined for a POI that needs to have updated location information.

In one scenario, a service provider receives a search request from a user device for location information of an initial POI, which is not yet available in its databases. Next, the service provider receives a subsequent search request from the user device for location information for a subsequent POI. In one embodiment, the service provider may use the location information of that subsequent POI to update location information of that initial POI (e.g., in one or more databases). Associating the location information of the two POIs may be based on a practice in some regions, where it may be customary or necessary to provide location information of a first POI with reference to location information of other nearby POIs. In some situations, providing the location information as such may be due to new construction of that certain POI, unsettled physical addressing schemes in the area, ease of reference or directions to a known landmark, or the like.

In one use case scenario, Susan wants to go to “Mary's Jewelry Store” in her city, but does not have an address for the store; so she submits a search request for navigation directions based on the name “Mary's Jewelry Store.” Further, the search results from a service provider may indicate that the location information for Mary's Jewelry Store or, in fact, the POI “Mary's Jewelry Store” cannot be found in available databases. Next, Susan finds out (e.g., in a newspaper ad, from a friend, etc.) that Mary's Jewelry Store is “located next to the City Library and across the street from the City Police Station.” Now, Susan knows that if she finds directions either to the City Library or to the City Police Station, she would be able to find Mary's Jewelry Store. So, now Susan submits a subsequent search request for directions to the City Library and/or to the City Police Station, which should direct her sufficiently close to Mary's Jewelry Store. In one example, the service provider may decide to tag/mark the location information of the City Library and/or the City Police Station as potential location information that may be used to update the location information for Mary's Jewelry Store. In one embodiment, a service provider may determine potential accuracy of location information for an unverified POI based on statistical analysis (e.g., distribution, frequency, etc.) of a multitude of search requests, from a plurality of users, associated with an initial POI and subsequent POIs in the search requests.

In one embodiment, a service provider may determine that a plurality of POIs or various information associated with the POIs are unidentified, unverified, missing, outdated, erroneous, or the like, wherein the service provider may utilize crowdsourcing methods for verifying and updating the POIs and their related information. For instance, the service provider may present a list of unverified POIs or related information items to a plurality of users/devices so that they can submit various information items to the service provider, which may be utilized to update the POIs and the related information. For example, the users may submit street-view pictures of the unverified POI structure/building or of a number on the building, a picture of another POI (e.g., verified/unverified) next to the unverified POI, descriptive text of that location, etc. In various embodiments, a service provider may compile potential information for updating/verifying an unverified POI, which may have been received from a plurality of users, and compare the instances of the potential information in order to determine most accurate information which should be used to update verify an unverified POI. For example, a service provider may have received 20 street-view pictures from various users who claim that the pictures are of a certain POI. Here, the service provider may compare the 20 pictures and determine if most or all substantially depict a similar subject matter and the pictures, where those pictures that are substantially similar may be used in updating and verifying the unverified POI.

In one embodiment, a service provider may present POIs and their information for updating via a crowdsourcing application (e.g., “WhereIs”) available at the user devices. For example, the crowdsourcing application may be launched at a user device by the user, by the service provider or the device based on the location of the user device. In one scenario, a service provider may determine that a user device is near the location of potential POIs, which may need to be updated, and so the service provider causes the crowdsourcing application or one or more other applications to be launched at the user device. In one embodiment, a service provider may be able to determine various sensory data from the user device for use in updating or verifying one or more POIs. In one embodiment, a service provider may provide online credits (e.g., virtual money) to the users/devices that may provide information for use in the updating or verifying of the POIs. For example, the users may utilize the online credits in various designated online or physical stores for discounts on various services or products. In one embodiment, the credits may be provided to a user once the service provider is able to confirm (e.g., compared to information provided by other users) that the information provided by the user is valid and relative to the POI at issue.

In one embodiment, a service provider may prioritize and rank any outstanding updating, validation, or verification associated with one or more POIs, where the prioritization/ranking may be based on the frequency of search requests for the one or more POIs that the service provider receives. For example, the service provider may receive large number of search requests from users for information on a new restaurant at the City Center, which is not yet updated or verified in available databases.

In one embodiment, users may utilize a crowdsourcing application to participate in (e.g., self-serve) and provide to service providers contextual information on a plurality of unverified POIs for updating and verifying the unverified POIs. For example, a user may be strolling through an area in the City Center when the user notices new stores are being constructed in place of previous stores, which the user was familiar with.

In one embodiment, the system 100 may determine at least one query from at least one device for location information associated with at least one point of interest. In one embodiment, a service provider may receive a query (search request) from a user who may wish to receive one or more services. In one example, a user may submit a request to a search service provider (e.g., a search engine), where the request may include various search/query terms indicating that the user wishes to receive one or more information items (e.g., location information) associated with a POI. In one example, a user may submit a location-based service request to a service provider, where the user may be seeking navigation directions from the user's current location to the location of the POI. In various examples, the services may be provided by one or more local/remote content or service providers, where they may or may not be able to determine and provide the requested information. In one example, the service providers may not be able to find the requested information on the POI in their databases.

In one embodiment, the system 100 may determine at least one next location visited by the at least one device. In one embodiment, a service provider may determine location information (e.g., GPS information) of the user, who submits a request for information on a POI, and then determine location information of the user subsequent to the request. For example, a user may utilize a user device (e.g., a mobile device, a navigation device, etc.) to submit a request to a service provider for navigation directions from his current location to the location of a POI, where the service provider may determine the user's current location. Further, the service provider may determine location information of the user after the user leaves his current position and travels to a next location. In one use case scenario, a user “John” may submit a request to a service provider for driving directions to a restaurant “A”, where if the service provider can determine the location information for restaurant “A”, then it may provide the driving directions to John. In one example, whether or not John receives the driving directions to restaurant “A”, John may still drive/travel to a next location (e.g., to the restaurant “A”, a restaurant “B”, go home, go to work, etc.), where the service provider can determine that next location (e.g., GPS information) where John travels to.

In one embodiment, the system 100 may cause, at least in part, an updating of the location information associated with the at least one point of interest based, at least in part, on the at least one next location. In one embodiment, the service provider may utilize location information of a user's next location to update location information of the POI (e.g., by associating location information of the next location with the location information of the POI.) Referring to our above example, if John requests driving directions to restaurant “A” and then drives to restaurant “B,” then the service provider can determine and associate the location information of restaurant “B” with location information of restaurant “A” in one or more databases.

In one embodiment, the system 100 may determine at least another query from the at least one device for other location information associated with at least one other point of interest, wherein the updating of the location information associated with the at least one point of interest is based, at least in part, on the other location information. In one use case scenario, a service provider may receive a request from a user device for location information of a POI “X,” where the service provider may or may not be able to determine its location information. In one instance, POI “X” or the location information of POI “X” may not exist in the service provider's or third-party databases, for example, POI “X” may be a new POI and its information may have not been entered into the databases yet. In one embodiment, the service provider may receive another search request from the user device for location information of a POI “Y,” where the service provider may be able to determine its location information available in one or more databases. In one embodiment, the service provider may utilize the location information of POI “Y” to update the location information of POI “X”. For example, a user may submit an initial search request for location information of bookstore “G” and then the user may submit a subsequent search request for location information of “City College,” where the service provider may use the location information of “City College” to update location information of bookstore “G” in one or more databases. In one use case scenario, the bookstore “G” may be located close to the “City College”. In various embodiments, a service provider may receive one or more initial search requests for a certain POI from one or more users and then receive one or more subsequent search requests for a different POI from the one or more users. For example, the service provider may receive five search requests from five users for location information of the bookstore “G”, and then it may receive three subsequent search requests from any of the five users for location information of the “City College”.

In one embodiment, the system 100 may determine a distribution of the at least one query relative to (a) the at least one next location, (b) the other location information, or (c) a combination thereof, wherein the updating of the location information is based, at least in part, on (a) the distribution, (b) a frequency of occurrence of the at least one next location, the other location information, or a combination thereof in the distribution, or (c) a combination thereof. In one embodiment, a service provider may analyze statistical information associated with an initial search request from a user for an initial POI, location information of the user's next location, or location information of a subsequent POI in a subsequent search request from the user. For example, the service provider may analyze distribution information and determine statistical information related to a search request for location information of POI “A”, POI “B”, and next location information of one or more users who submitted to search requests for location information of POI “A” and POI “B”. In one use case scenario, a service provider may determine that there have been 100 initial search requests on POI “A”, 80 subsequent search requests on POI “B”, and 70 similar next location information for the users' associated with the search requests on POI “A” and POI “B”. In one embodiment, the service provider may update location information of an initial POI in an initial search request based, at least in part, on the determined statistical information associated with frequency of occurrence of the next location of the user and/or location information of a subsequent POI in a subsequent search request. In the example above, the service provider may determine from the statistical information associated with the search requests on POI “A” and POI “B” (e.g., 100 and 80 respectively) that to POIs may be related (e.g., in close proximity location, similar types of POI, etc.) and therefore it may update the location information of the POI “A” (e.g., in one or more databases) with location information of the POI “B”. Similarly, the service provider may utilize one or more users' next location statistical information (e.g., 70) to update the location information of the POI “A”.

In one embodiment, the system 100 may cause, at least in part, an initiation of the determination of the at least one next location, the updating of the location information, or a combination thereof based, at least in part, on a determination that the at least one query produces at least one null result, at least one invalid result, or a combination thereof. In one embodiment, a service provider may analyze a response to a search request on a POI and determine whether the response included a result and if so, did the result include one or more invalid, erroneous, expired, or the like result elements. For example, a response to a search request for information on a certain POI may indicate that the service provider and/or one or more other content/service providers were not able to determine the requested information (e.g., null, empty, the POI does not exist in one or more databases, etc.) In one example, the search result may include one or more information items, which, however, may be identified/tagged/marked by one or more users and/or service providers as invalid, erroneous, outdated, or the like, where the information items may need to be validated/updated. In various embodiments, if a service provider determines that a search result to a search request on a POI does not include any information (e.g., empty, null) or that the result includes invalid information (e.g., unverified), then one or more content/service providers may initiate one or more processes/tasks to update or validate one or more information items associated with a POI.

In one embodiment, the system 100 may cause, at least in part, a designation of the updating of the location information for the at least one point of interest as one or more unverified updates. In one embodiment, a service provider may mark, tag, or designate a POI and one or more related information items for updating or verification. In one instance, the POI may be tagged and listed in one or more lists with one or more service/content providers for updating or verification. For example, a certain restaurant location may be marked for verification, where there may be no location information or that any existing location information may need to be verified or updated. For instance, a new restaurant is identified to be at the City Center, but there is no address information listed for it. In one embodiment, POIs designated for updating or verification may be listed in one or more lists, which may be accessed or shared by a plurality of service/content providers.

In one embodiment, the system 100 may determine the one or more unverified updates, one or more potential points of interest, or a combination thereof based, at least in part, on a monitoring of one or more locations at which the one or more verifying devices aggregate. In one embodiment, based on location information of user devices, a service provider may determine that a plurality of the user devices is located in close proximity to each other. For example, the plurality of the user devices may be located/gathered at a certain location near the City Center. Further, the service provider may compare the location information of the gathering to location information of known or unverified POIs in one or more databases. For instance, the service provider may determine that the plurality of devices is gathered near a known college and/or near the location of an unverified coffee shop (e.g., a new coffee shop). In one embodiment, the service provider may determine that the gathering location of the plurality of devices does not necessarily correspond (e.g., “unknown”) to locations of a known or unverified POIs, therefore, the service provider may mark designate this “unknown” location for identification, verification, and updating.

In one embodiment, the system 100 may cause, at least in part, a prioritization of the one or more unverified updates based, at least in part, on a frequency of queries for the at least one point of interest associated with the one or more unverified updates. In one embodiment, a service provider may determine one or more priority or ranking levels for updating one or more unverified information items associated with one or more POIs, wherein the prioritization may be based on a frequency of queries/search requests received for the unverified information items. In one instance, a service provider may receive a large number of search requests for information on an unverified POI, whereby updating of this unverified POI may be prioritized over updating of other POIs. For example, a service provider may receive a large number of queries for location information of a new skating rink near a shopping mall, where the service provider may prioritize (e.g., high-priority) the updating of the location information for the skating rink.

In one embodiment, the system 100 may cause, at least in part, a submission of the one or more unverified updates for a crowd-sourced verification to one or more verifying devices. In one embodiment, the submission of the one or more unverified updates for the crowd-sourced verification is based, at least in part, on the prioritization of the one or more unverified updates. In one embodiment, a service provider may present/submit one or more unverified update requests/opportunities to one or more user devices, which may be able to assist with updating one or more information items associated with one or more unverified POIs. For example, a service provider may present to a plurality of user devices a list or a mapping of one or more unverified updates associated with one or more POIs, so that the user devices may be able to provide information for verification and updating.

In one embodiment, the system 100 may cause, at least in part, one or more updates to the one or more unverified updates based, at least in part, on contextual information associated with the at least one point of interest received from the one or more verifying devices. In one embodiment, a service provider may receive one or more information items from one or more user devices for updating one or more unverified information items associated with one or more POIs, wherein the POIs may be known, unknown, or unverified. For example, a user device may provide location information (e.g., physical address, GPS coordinates, etc.) and a location picture for a POI, which the service provider may utilize for updating information associated with a POI.

In one embodiment, the system 100 may determine the one or more verifying devices based, at least in part, on a proximity of the one or more verifying devices to the at least one point of interest associated with the one or more unverified updates. In one embodiment, a service provider may determine a current location information of a user device and then present a list of one or more information items associated with one or more POIs, which may be near the current location of the user device. For example, the service provider may determine that a user device is currently near the location of an unverified bookstore and then the service provider would present at the user device the unverified bookstore information so that the user device (e.g., an application) or the user of the user device may capture or provide one or more (e.g., physical address and a street-view picture) information items associated with the unverified bookstore. In one embodiment, a service provider may present/provide a credit to a user/device for participating in providing information to be utilized for verification an unverified update. For example, the service provider may provide one or more online credit points to a verifying user/device, where the credit points may be utilized in a variety of online stores or activities. In one embodiment, the number of credit points provided may be based on the priority or ranking of the unverified updates. For example, a service provider may provide more credit points for updating a high-priority unverified update so that more users may be incentivized to participate in updating that high-priority unverified update.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as application/applications 103) including social networking, web browser, crowdsourcing, communications, content sharing, multimedia applications, user interface (UI), map application, web client, etc. to communicate with other UEs 101, one or more service providers 105a-105n (also collectively referred to as service providers 105), one or more content providers 107a-107n (also collectively referred to as content providers 107), one or more satellites 109a-109n (also collectively referred to as satellites 109), one or more updating platforms 113a-113n (also collectively referred to as updating platform 113), and/or with other components of the system 100 directly and/or via a communication network 111.

In one embodiment, the UEs 101 may include data/content collection modules 115a-115n (also collectively referred to as DC module 115) for determining and/or collecting data and/or content associated with the UEs 101, one or more users of the UEs 101, applications 103, one or more content streams (e.g., multimedia content), and the like. In addition, the UEs 101 can execute an application 103 that is a software client for storing, processing, and/or forwarding one or more information items to other components of the system 100. In various embodiments, the DC module 115 may include various sensors for detecting various signals, for example, audio, optical, Bluetooth, near field communication (NFC), RFID, or the like.

In one embodiment, the applications 103 may be utilized to search or request for information from various content and/or service provider websites for consumption at a UE 101. For example, a user may utilize a UE 101 to search and request for information associated with various POIs. In one example, the user may wish to receive navigation information from one location to locations of one or more POIs, where the POIs may be identified by name, location, type of POI, area/region of the POI, by location of a user, or the like. In another example, the applications 103 may include one or more applications for participating in and providing outsourced information to one or more content/service providers. In one example, a crowdsourcing application may be launched by a user of the UE 101, another application at the UE 101, or a service provider may cause the launching of the contrasting application at the UE 101. In various embodiments, the crowdsourcing application may operate in conjunction with other applications 103 and/or the DC module 115 for collecting various information items associated with a POI and for submitting the information to one or more content/service providers. In one example, the crowdsourcing application may interact with a mapping application for determining locations of one or more unverified POIs, and then collect various contextual information via one or more sensors at the UE101 for submitting to the updating platform 113.

In one embodiment, the service providers 105 may include and/or have access to one or more service databases 117a-117n (also collectively referred to as service database 117), which may include various user information, user profiles, user preferences, one or more profiles of one or more user devices (e.g., device configuration, sensors information, etc.), service providers 105 information, other service providers' information, and the like. In one embodiment, the service providers 105 may include one or more service providers offering one or more services, for example, location-based services, navigation services, search engines, online shopping, social networking services (e.g., blogging), content sharing, media upload, media download, media streaming, account management services, or a combination thereof. Further, the service providers 105 may conduct a search for information related to one or more POIs, navigation services, media items, coupons, and the like.

In one embodiment, the content providers 107 may include and/or have access to one or more content database 119a-119n (also collectively referred to as content database 119), which may store, include, and/or have access to various contents and information associated with various POIs at various geo-locations. For example, the content providers 107 may store content (e.g., at the content database 119) which may have been provided by various users, various service providers, crowd-sourced content, and the like. Further, the service providers 105 and/or the content providers 107 may utilize one or more service application programming interfaces (APIs)/integrated interface, through which communication, media, content, and information (e.g., associated with users, applications, services, content, etc.) may be shared, accessed and/or processed. In one embodiment, a content provider 107 may provide location information to a plurality of users, the service providers 105, and/or the updating platforms 113. In various examples, a content provider may be an original content producer and/or a content distributor.

In one embodiment, the updating platform 113 may include and/or have access to one or more updating database 121a-121n (also collectively referred to as updating database 121). The updating platform 113 may exist in whole or in part within the service providers 105, the content providers 107, the UEs 101, or it may be implemented as a stand-alone platform. In one embodiment, the updating platform 113 may utilize one or more servers, applications, algorithms, software, or the like to collect, store, verify, validate, provide, or update various information items associated with one or more POIs. In one embodiment, the updating platform 113 may receive or provide the information/metadata regarding various POIs from or to the content providers 107, the service providers 105, and/or the UEs 101. In one embodiment, the updating platform 113 may utilize one or more crowdsourcing mechanisms for determining or receiving information related to various POIs from a plurality UEs 101. In one embodiment, the updating platform 113 may generate, monitor, and update a list of POIs or information items associated with the POIs, which may need to be verified and updated. In one embodiment, the updating platform 113 may provide its services to the service providers 105 or to the content providers 107.

Generally, the UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, loud speakers, display monitors, radio broadcast receiver, electronic book device, game device, wrist watch, or any combination thereof, including the accessories and peripherals of these devices, or any combination thereof. It is also contemplated that the UEs can support any type of interface to the user (such as “wearable” circuitry, etc.) Further, the UEs 101 may include various sensors for collecting data associated with a user, a user's environment, and/or with a UE 101, for example, the sensors may determine and/or capture audio, video, images, atmospheric conditions, device location, user mood, ambient lighting, user physiological information, device movement speed and direction, and the like.

In one embodiment, the UE 101 includes a location module/sensor that can determine the UE 101 location (e.g., a user's location). The UE 101 location may be determined by a triangulation system such as a GPS, assisted GPS (A-GPS), Cell of Origin, wireless local area network triangulation, or other location extrapolation technologies. Standard GPS and A-GPS systems can use the one or more satellites 109 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., LAN, WLAN) connection to determine the UE 101 location information, for example, from an Internet source (e.g., a service provider).

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, the service providers 105, the content providers 107, the satellites 109, and the updating platform 113 may communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the UEs 101, the service providers 105, the content providers 107, and the updating platform 113 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

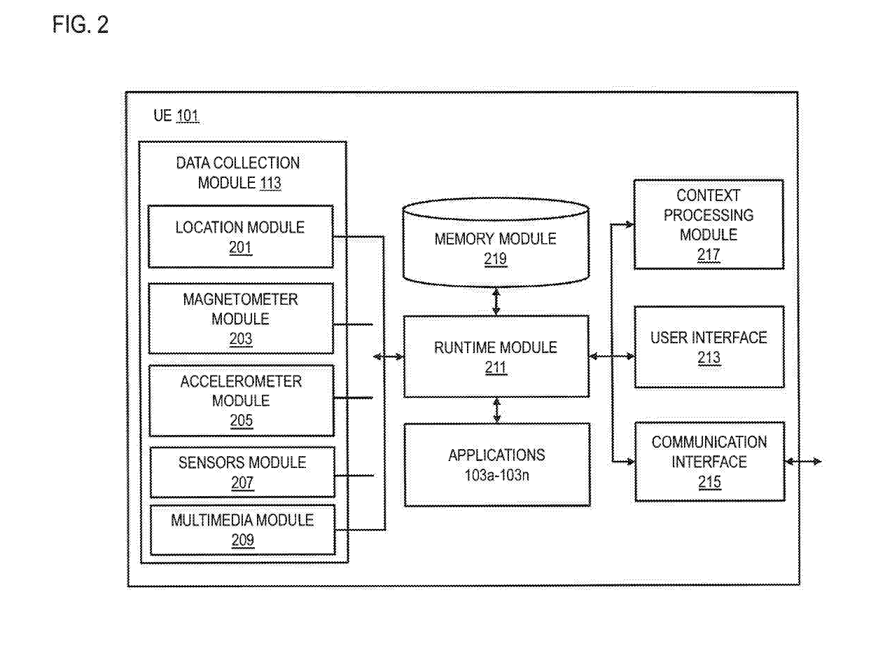

FIG. 2 is a diagram of the components of a user equipment capable of receiving information and submitting crowdsourcing information, according to an embodiment. By way of example, a UE 101 includes one or more components for executing various applications for enabling a user to request, receive, and consume various information from the service providers 105, content providers 107, and/or the updating platforms 113. Further, the UE 101 may perform one or more tasks associated with gathering and submitting information in crowdsourcing activities. It is contemplated that the functions of these components may be combined in one or more components or performed by other components of equivalent functionality. In this embodiment, the UE 101 includes a DC module 115 that may include one or more location modules 201, magnetometer modules 203, accelerometer modules 205, sensors module 207, and multimedia module 209. Further, the UE 101 may also include a runtime module 211 to coordinate the use of other components of the UE 101, a user interface 213, a communication interface 215, a context processing module 217, and a memory module 219. The applications 103 of the UE 101 can execute on the runtime module 211 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 109 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory module 219 and are available to the context processing module 217, the DC module 115, the service providers 105, and/or to other entities of the system 100 (e.g., via the communication interface 215.) Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory module 219, made available to other modules and/or applications 103 of the UE 101, and/or transmitted via the communication interface 215 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory module 219, made available to other modules and/or applications 103 of the UE 101, and/or sent to one or more entities of the system 100.

In various embodiments, the sensors module 207 can process sensor data from various sensors (e.g., microphone, optical, Bluetooth, NFC, GPS, accelerometer, gyroscope, thermometer, etc.) to determine environmental (e.g., atmospheric) conditions surrounding the UE 101, user mood (e.g., hungry, angry, tired, etc.), location information, and various other information from a range sensors that may be available on one or more devices. For example, the sensors module 207 may detect conditions including humidity, temperature, geo-location, biometric data of the user, etc. Once again, this information can be stored in the memory module 219 and sent to the context processing module 217 and/or to other entities of the system 100. In certain embodiments, information collected from the DC collection module 115 can be retrieved by the runtime module 211 and stored in memory module 219, made available to other modules and/or applications 103 of the UE 101, and/or sent to one or more entities of the system 100.

In one embodiment, the multimedia module 209 may be utilized to request and/or consume various content and information associated with one or more POIs, which may be available from a service provider 105, a content provider 107, or an updating platform 113. In various embodiments, the multimedia module 209 may interface with the applications 103 for requesting and/or consuming the various content and information. In one embodiment, the multimedia module 209 may be utilized to capture various media items, for example, images, video, audio, and the like, wherein the captured media may be submitted to one or more modules and applications of the UE 101, the service provider 105, the content provider 107, or the updating platform 113, which may be utilized as crowd-sourced content/information in updating and verifying associated POIs. In various embodiments, the multimedia module 209 may interface with various sensors; for example, a camera, a microphone, etc., to capture the media items at a UE 101.

In one embodiment, the communication interface 215 can be used to communicate with one or more entities of the system 100, for example, to submit a request for and receive content and information associated with various POIs. Further, a UE 101 may submit various content and information via the communication interface 215 to one or more elements of the system 100. In various embodiments, the communication interface 215 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the communication network 111). In some examples, the UE 101 can send contextual information associated with the UE 101 or one or more POIs to the service providers 105, the content providers 107, the updating platform 113, and/or to other entities of the system 100.

The user interface 213 can include various methods for a user to interface with applications, modules, sensors, and the like at a UE 101. For example, the user interface 213 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

The context processing module 217 may be utilized in determining contextual information associated with content and information received or generated at the UE 101. For example, the context processing module 217 may determine information about the context of an image, of a video, of an audio recording, of a map representation, or the like, which may be accomplished by interacting with the DC module 115 or the applications 103 executing on the runtime module 211. Further, that information may be caused to be transmitted, via the communication interface 215, to the service providers 105, the content providers 107, the updating platform 113, and/or to other entities of the system 100. The context processing module 217 may additionally be utilized as a means for determining information related to the user, an instance of data, a value, a content item, a POI, an object, a subject, and the like. In certain embodiments, the context processing module 217 can infer higher level context information from the context data such as favorite locations, significant places, common activities, interests in products and services, POIs at various geo-locations, etc. In various embodiments, the runtime module may cause one or more modules/components of a UE 101 to associate one or more available data items with one or more content or information items available from the one or more modules/components of the UE 101. For example, date, time, location, and user information associated with a device at a particular time may be associated (e.g., as metadata) with an image that is captured by the UE 101 at that particular time.

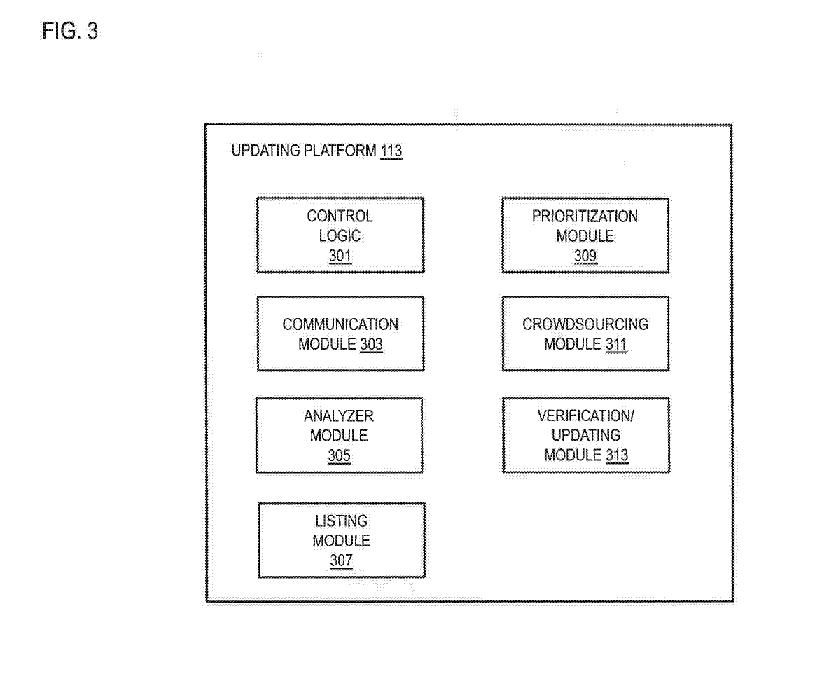

FIG. 3 is a diagram of the components of an updating platform, according to an embodiment. By way of example, the updating platform 113 includes one or more components for determining, verifying, and updating information associated with one or more POIs. It is contemplated that the functions of these components may be combined in one or more components or performed by other components of equivalent functionality. In this embodiment, the updating platform 113 includes a control logic 301, a communication module 303, an analyzer module 305, a listing module 307, a prioritization module 309, a crowdsourcing module 311, and a verification/updating module 313. In various embodiments, the updating platform 113 may include or have access to various processors (e.g., central processing units (CPU), digital signal processors (DSP), etc.), algorithms, applications, programs, software, or the like for effectuating one or more processes associated with updating information related to one or more POIs. Further, the services of the updating platform 113 may be made available to the service providers 105, the content providers 107, to the UEs 101, or other elements of the system 100. As noted, the updating platform 113 may be implemented in whole or in part within the service providers 105, the content providers 107, the UEs 101, or it may be implemented as a stand-alone platform.

The control logic 301 oversees tasks performed by the various modules and components of the updating platform 113. Although other modules may perform the actual task, the control logic 301 may determine when and how those tasks are performed or otherwise direct the other modules to perform various tasks.

The communication module 303 is used for communication between updating platform 113 and the UEs 101, the service providers 105, the content providers 107, and/or other elements of the system 100. The communication module 303 may also be used to receive/transmit various contents, information items, feedback, statistics, or the like from/to the UEs 101, the service providers 105, the content providers 107, or the like. In one embodiment, the communication module 303 may receive a request or notification from the UEs 101, the service providers 105, the content providers 107, and/or other elements of the system 100 to analyze, verify, and potentially update information related to one or more POIs. For example, a service provider 105 may submit a search result (e.g., a response to a user search request), wherein the search result may include one or more unverified, erroneous, expired, or the like information items associated with one or more POIs. Also, the search result may indicate that no information items were found for the one or more POIs, or that the one or more POIs were not listed in one or more databases.

The analyzer module 305, in connection with the communication module 303, may be used to process and analyze the search results and determine any potential issues therein. For example, the analyzer module 305 may determine that one or more information items provided in the search results may be unverified or expired that may need to be verified and updated. In one example, the analysis may indicate that no information were found for one or more POIs included in one or more search requests from one or more users. In one example, the analysis may indicate that a service provider 105 was unable to find any records for the one or more POIs. In one scenario, a search request may have been for information on a new POI, where the POI has not been listed in any databases yet. In one embodiment, the analyzer module 305 may analyze and utilize location information of one or more UEs 101 next location in order to ascertain whether the next location potentially may be utilized and associated with a POI.

In one embodiment, the analyzer module 305 may provide its analysis results to the listing module 307, where the listing module 307 may further process the analysis results and generate a listing of information items associated with one or more POIs and/or a list of one or more POIs that may need to be verified and updated. For example, the listing may include location information for a POI, which may need to be verified and updated in one or more databases. In one example, the listing may include one or more POIs which were not found in one or more databases. In one embodiment, the listing module 307 may share the one or more lists with the service providers 105, the content providers 107, or that UEs 101. In one embodiment, the analyzer module 305 may process and analyze location information of a geo-location where one or more UEs 101 may have gathered and compare that location information to location information of one or more POIs and determine whether the gathering location is substantially near the one or more POIs. In one scenario, the gathering location may be identified as a potential location information for updating a POI. For example, the gathering location information may be presented to the verification/updating module 313 for further evaluation and verification.

In one embodiment, the prioritization module 309 may prioritize the verification and updating of the information items or the POIs presented in one or more lists provided by the listing module 307. For example, the prioritization module 309 may utilize one or more characteristics associated with the information items or the POIs that may need to be verified and updated, wherein the characteristics may be determined by the service provider 105, the content provider 107, or the UEs 101. In one scenario, a POI may have high priority for verification and updating if that POI is the subject of frequent (e.g., very popular) search requests by a plurality of UEs 101. In one example, the location information of a certain POI may be designated with a high priority if numerous users indicate to the service providers 105 that the location information is erroneous and in need of updating. In one embodiment, the priority levels may be based, at least in part, on a fee-based service provided by the updating platform 113. For example, a service/content provider may pay certain fees for prioritizing verification and updating of information associated with certain POIs, or for verifying and updating information for a new POI.

In various embodiments, the crowdsourcing module 311 may operate with in conjunction with the listing module 307 and the prioritization module 309 to initiate various crowdsourcing processes for verifying and updating various items, e.g., the information and the POIs, provided by the listing module 307. In one embodiment, the crowdsourcing module 311 may select or receive one or more POIs from the prioritization module 309 for verification and updating via one or more UEs 101, wherein the crowdsourcing module 311 may further process each item for initiating the crowdsourcing processes. For example, the crowdsourcing module 311 may determine the type of verification and updating that may be associated with a POI; for instance, the existence of a new POI may need to be verified and then updated into one or more databases. In one example, a POI may already be listed in one or more databases, but one or more information items (e.g., location, images, etc.) may still need to be verified and updated. In one embodiment, the crowdsourcing module 311 may organize and present various items for verification to a plurality of UEs 101 based, at least in part, on the priority of an item, location of the item, location of a UE 101, or the like. In one embodiment, the crowdsourcing module 311 may communicate with the prioritization module 309 and the listing module 307 for providing status information on one or more items on the lists provided by the listing module 307 or the prioritization module 309. For example, the crowdsourcing module 311 may indicate to the listing module that an item on a verification list has been sent out to one or more UEs 101 for verification. In one example, the crowdsourcing module 311 may indicate to the prioritization module 309 that an item with a certain priority has been sent out several times for verification, but no verification information has been received yet. In one embodiment, the crowdsourcing module 311 may organize verification and updating requests received from various service or content providers. In one embodiment, the crowdsourcing module 311 may cause the launching of a crowdsourcing application at one or more UEs 101, whereby one or more items for verification may be presented at the UEs 101.

In one embodiment, the verification/updating (updating) module 313 may receive and process various information items associated with one or more POIs from the UEs 101 or other elements of the system 100, which may be used in verification and updating of the POIs in one or more databases. For example, the updating module 313 may receive and analyze crowd-sourced information related to a POI from the crowdsourcing module 311 (e.g., received from various sources or UEs 101) and then compare the various information in order to ascertain potential accuracy of the information. In one embodiment, the updating module 313 may determine a verification accuracy rate and statistics for information related to a POI, wherein the accuracy rate or the statistics may be utilized in determining whether to update the information onto various databases. In one embodiment, the updating module 313 may notify the listing module 307, the prioritization module 309, or the crowdsourcing module 311 once the updating module 313 has verified and updated information on one or more POIs so that the other modules can update their lists according to the verified/updated items. In one embodiment, the updating module 313 may utilize location information of one or more UEs 101 next location for verifying and updating the location information of a POI.

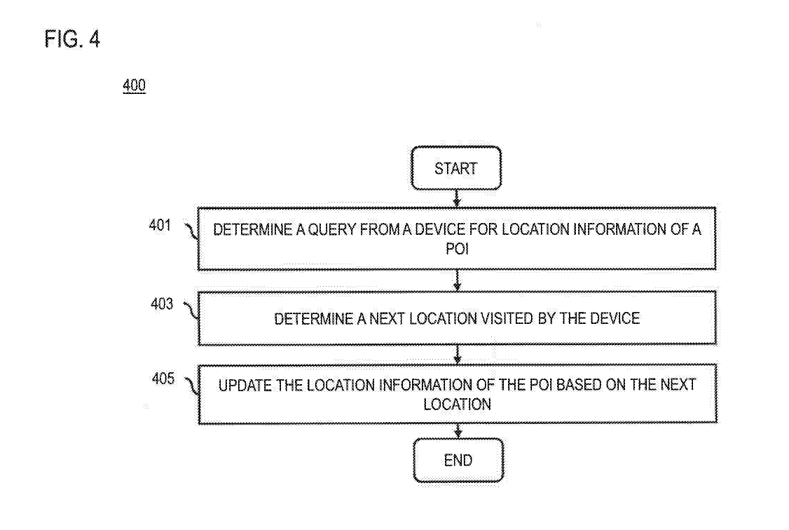

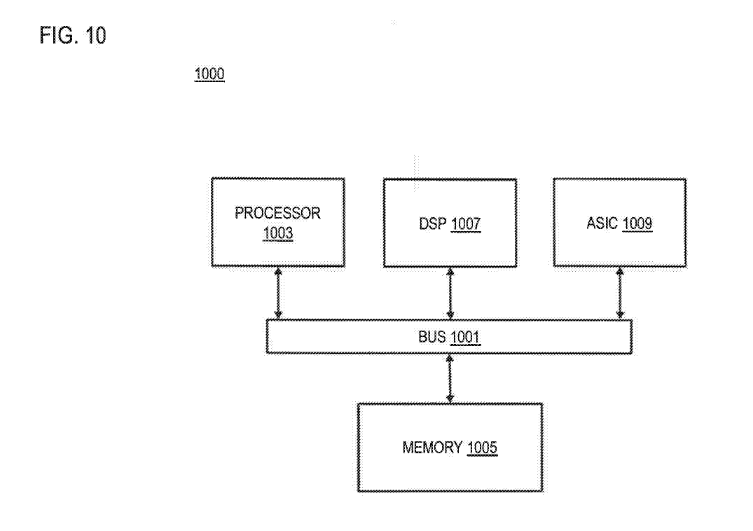

FIGS. 4 through 6 illustrate flowcharts of various processes for, at least, updating or validating information associated with potential points of interest using crowd sourcing methods, according to various embodiments. In various embodiments, the updating platform 113 and/or the UE 101 may perform processes 400, 500, and 600 that may be implemented, for instance, in a chip set including a processor and a memory as shown in FIG. 10. As such, the location updating platform 113 can provide means for accomplishing various parts of the process 400, 500, and 600 as well as means for accomplishing other processes in conjunction with other components of the system 100. Throughout this process, the updating platform 113 may be referred to as completing various portions of the processes 400, 500, and 600, however, it is understood that other components of the system 100 can perform some of and/or all of the process steps.

Referring to FIG. 4, the process 400 begins at step 401 where the updating platform 113 may determine at least one query from at least one device for location information associated with at least one point of interest. In one embodiment, a service provider may receive a query (search request) from a user who may wish to receive one or more services. In one example, a user may submit a request to a search service provider (e.g., a search engine), where the request may include various search/query terms indicating that the user wishes to receive one or more information items (e.g., location information) associated with a POI. In one example, a user may submit a location-based service request to a service provider, where the user may be seeking navigation directions from the user's current location to the location of the POI. In various examples, the services may be provided by one or more local/remote content or service providers, where they may or may not be able to determine and provide the requested information. In one example, the service providers may not be able to find the requested information on the POI in their databases.

In step 403, the updating platform 113 may determine at least one next location visited by the at least one device. In one embodiment, a service provider may determine location information (e.g., GPS information) of the user, who submits a request for information on a POI, and then determine location information of the user subsequent to the request. For example, a user may utilize a user device (e.g., a mobile device, a navigation device, etc.) to submit a request to a service provider for navigation directions from his current location to the location of a POI, where the service provider may determine the user's current location. Further, the service provider may determine location information of the user after the user leaves his current position and travels to a next location. In one use case scenario, a user “John” may submit a request to a service provider for driving directions to a restaurant “A”, where if the service provider can determine the location information for restaurant “A”, then it may provide the driving directions to John. In one example, whether or not John receives the driving directions to restaurant “A”, John may still drive/travel to a next location (e.g., to the restaurant “A”, a restaurant “B”, go home, go to work, etc.), where the service provider can determine that next location (e.g., GPS information) where John travels to.

In step 405, the updating platform 113 may cause, at least in part, an updating of the location information associated with the at least one point of interest based, at least in part, on the at least one next location. In one embodiment, the service provider may utilize location information of a user's next location to update location information of the POI (e.g., by associating location information of the next location with the location information of the POI.) Referring to our above example, if John requests driving directions to restaurant “A” and then drives to restaurant “B,” then the service provider can determine and associate the location information of restaurant “B” with location information of restaurant “A” in one or more databases.

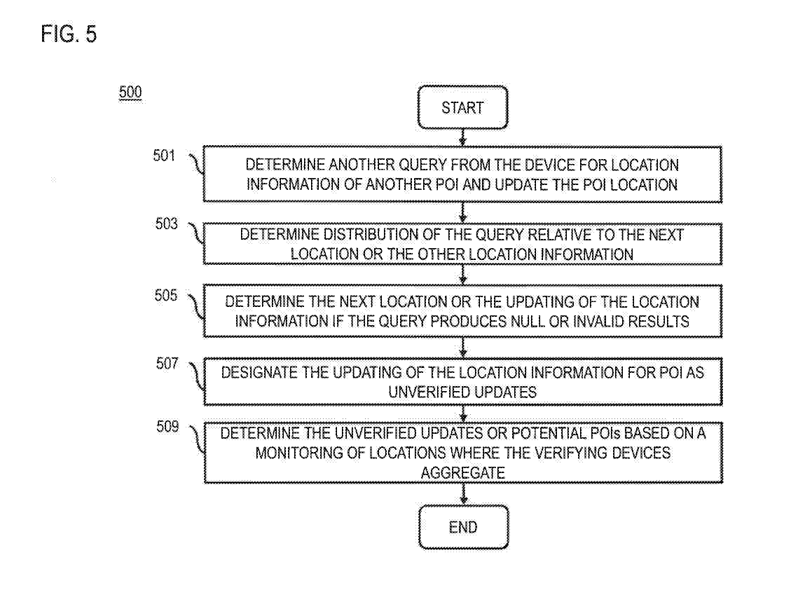

Referring to FIG. 5, the process 500 begins at step 501 where the updating platform 113 may determine at least another query from the at least one device for other location information associated with at least one other point of interest, wherein the updating of the location information associated with the at least one point of interest is based, at least in part, on the other location information. In one use case scenario, a service provider may receive a request from a user device for location information of a POI “X,” where the service provider may or may not be able to determine its location information. In one instance, POI “X” or the location information of POI “X” may not exist in the service provider's or third-party databases, for example, POI “X” may be a new POI and its information may have not been entered into the databases yet. In one embodiment, the service provider may receive another search request from the user device for location information of a POI “Y,” where the service provider may be able to determine its location information available in one or more databases. In one embodiment, the service provider may utilize the location information of POI “Y” to update the location information of POI “X”. For example, a user may submit an initial search request for location information of bookstore “G” and then the user may submit a subsequent search request for location information of “City College,” where the service provider may use the location information of “City College” to update location information of bookstore “G” in one or more databases. In one use case scenario, the bookstore “G” may be located close to the “City College”. In various embodiments, a service provider may receive one or more initial search requests for a certain POI from one or more users and then receive one or more subsequent search requests for a different POI from the one or more users. For example, the service provider may receive five search requests from five users for location information of the bookstore “G”, and then it may receive three subsequent search requests from any of the five users for location information of the “City College”.

In step 503, the updating platform 113 may determine a distribution of the at least one query relative to (a) the at least one next location, (b) the other location information, or (c) a combination thereof, wherein the updating of the location information is based, at least in part, on (a) the distribution, (b) a frequency of occurrence of the at least one next location, the other location information, or a combination thereof in the distribution, or (c) a combination thereof. In one embodiment, a service provider may analyze statistical information associated with an initial search request from a user for an initial POI, location information of the user's next location, or location information of a subsequent POI in a subsequent search request from the user. For example, the service provider may analyze distribution information and determine statistical information related to a search request for location information of POI “A”, POI “B”, and next location information of one or more users who submitted to search requests for location information of POI “A” and POI “B”. In one use case scenario, a service provider may determine that there have been 100 initial search requests on POI “A”, 80 subsequent search requests on POI “B”, and 70 similar next location information for the users' associated with the search requests on POI “A” and POI “B”. In one embodiment, the service provider may update location information of an initial POI in an initial search request based, at least in part, on the determined statistical information associated with frequency of occurrence of the next location of the user and/or location information of a subsequent POI in a subsequent search request. In the example above, the service provider may determine from the statistical information associated with the search requests on POI “A” and POI “B” (e.g., 100 and 80 respectively) that to POIs may be related (e.g., in close proximity location, similar types of POI, etc.) and therefore it may update the location information of the POI “A” (e.g., in one or more databases) with location information of the POI “B”. Similarly, the service provider may utilize one or more users' next location statistical information (e.g., 70) to update the location information of the POI “A”.

In step 505, the updating platform 113 may cause, at least in part, an initiation of the determination of the at least one next location, the updating of the location information, or a combination thereof based, at least in part, on a determination that the at least one query produces at least one null result, at least one invalid result, or a combination thereof. In one embodiment, a service provider may analyze a response to a search request on a POI and determine whether the response included a result and if so, did the result include one or more invalid, erroneous, expired, or the like result elements. For example, a response to a search request for information on a certain POI may indicate that the service provider and/or one or more other content/service providers were not able to determine the requested information (e.g., null, empty, the POI does not exist in one or more databases, etc.) In one example, the search result may include one or more information items, which, however, may be identified/tagged/marked by one or more users and/or service providers as invalid, erroneous, outdated, or the like, where the information items may need to be validated/updated. In various embodiments, if a service provider determines that a search result to a search request on a POI does not include any information (e.g., empty, null) or that the result includes invalid information (e.g., unverified), then one or more content/service providers may initiate one or more processes/tasks to update or validate one or more information items associated with a POI.

In step 507, the updating platform 113 may cause, at least in part, a designation of the updating of the location information for the at least one point of interest as one or more unverified updates. In one embodiment, a service provider may mark, tag, or designate a POI and one or more related information items for updating or verification. In one instance, the POI may be tagged and listed in one or more lists with one or more service/content providers for updating or verification. For example, a certain restaurant location may be marked for verification, where there may be no location information or that any existing location information may need to be verified or updated. For instance, a new restaurant is identified to be at the City Center, but there is no address information listed for it. In one embodiment, POIs designated for updating or verification may be listed in one or more lists, which may be accessed or shared by a plurality of service/content providers.

In step 509, the updating platform 113 may determine the one or more unverified updates, one or more potential points of interest, or a combination thereof based, at least in part, on a monitoring of one or more locations at which the one or more verifying devices aggregate. In one embodiment, based on location information of user devices, a service provider may determine that a plurality of the user devices is located in close proximity to each other. For example, the plurality of the user devices may be located/gathered at a certain location near the City Center. Further, the service provider may compare the location information of the gathering to location information of known or unverified POIs in one or more databases. For instance, the service provider may determine that the plurality of devices is gathered near a known college and/or near the location of an unverified coffee shop (e.g., a new coffee shop). In one embodiment, the service provider may determine that the gathering location of the plurality of devices does not necessarily correspond (e.g., “unknown”) to locations of a known or unverified POIs, therefore, the service provider may mark designate this “unknown” location for identification, verification, and updating.

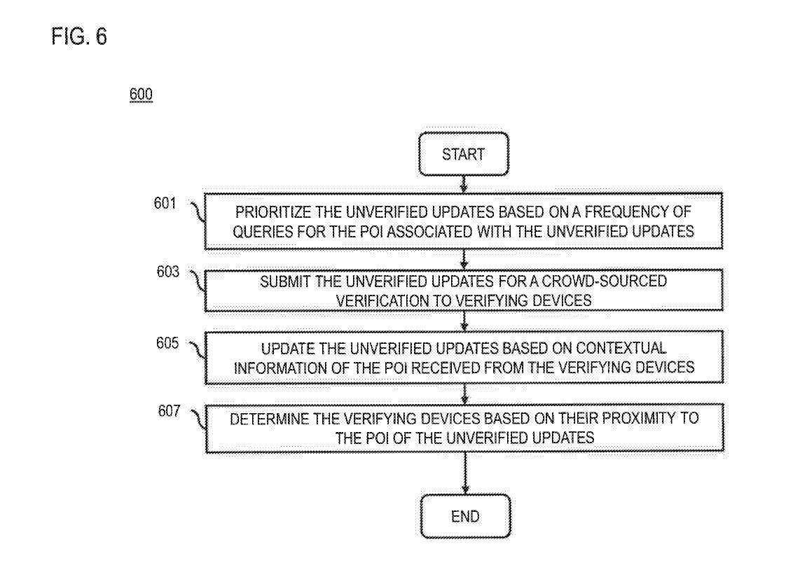

Referring to FIG. 6, the process 600 begins at step 601 where the updating platform 113 may cause, at least in part, a prioritization of the one or more unverified updates based, at least in part, on a frequency of queries for the at least one point of interest associated with the one or more unverified updates. In one embodiment, a service provider may determine one or more priority or ranking levels for updating one or more unverified information items associated with one or more POIs, wherein the prioritization may be based on a frequency of queries/search requests received for the unverified information items. In one instance, a service provider may receive a large number of search requests for information on an unverified POI, whereby updating of this unverified POI may be prioritized over updating of other POIs. For example, a service provider may receive a large number of queries for location information of a new skating rink near a shopping mall, where the service provider may prioritize (e.g., high-priority) the updating of the location information for the skating rink.

In step 603, the updating platform 113 may cause, at least in part, a submission of the one or more unverified updates for a crowd-sourced verification to one or more verifying devices. In one embodiment, the submission of the one or more unverified updates for the crowd-sourced verification is based, at least in part, on the prioritization of the one or more unverified updates. In one embodiment, a service provider may present/submit one or more unverified update requests/opportunities to one or more user devices, which may be able to assist with updating one or more information items associated with one or more unverified POIs. For example, a service provider may present to a plurality of user devices a list or a mapping of one or more unverified updates associated with one or more POIs, so that the user devices may be able to provide information for verification and updating.

In step 605, the updating platform 113 may cause, at least in part, one or more updates to the one or more unverified updates based, at least in part, on contextual information associated with the at least one point of interest received from the one or more verifying devices. In one embodiment, a service provider may receive one or more information items from one or more user devices for updating one or more unverified information items associated with one or more POIs, wherein the POIs may be known, unknown, or unverified. For example, a user device may provide location information (e.g., physical address, GPS coordinates, etc.) and a location picture for a POI, which the service provider may utilize for updating information associated with a POI.

In step 607, the updating platform 113 may determine the one or more verifying devices based, at least in part, on a proximity of the one or more verifying devices to the at least one point of interest associated with the one or more unverified updates. In one embodiment, a service provider may determine current location information of a user device and then present a list of one or more information items associated with one or more POIs, which may be near the current location of the user device. For example, the service provider may determine that a user device is currently near the location of an unverified bookstore and then the service provider would present at the user device the unverified bookstore information so that the user device (e.g., an application) or the user of the user device may capture or provide one or more (e.g., physical address and a street-view picture) information items associated with the unverified bookstore. In one embodiment, a service provider may present/provide a credit to a user/device for participating in providing information to be utilized for verification an unverified update. For example, the service provider may provide one or more online credit points to a verifying user/device, where the credit points may be utilized in a variety of online stores or activities. In one embodiment, the number of credit points provided may be based on the priority or ranking of the unverified updates. For example, a service provider may provide more credit points for updating a high-priority unverified update so that more users may be incentivized to participate in updating that high-priority unverified update.

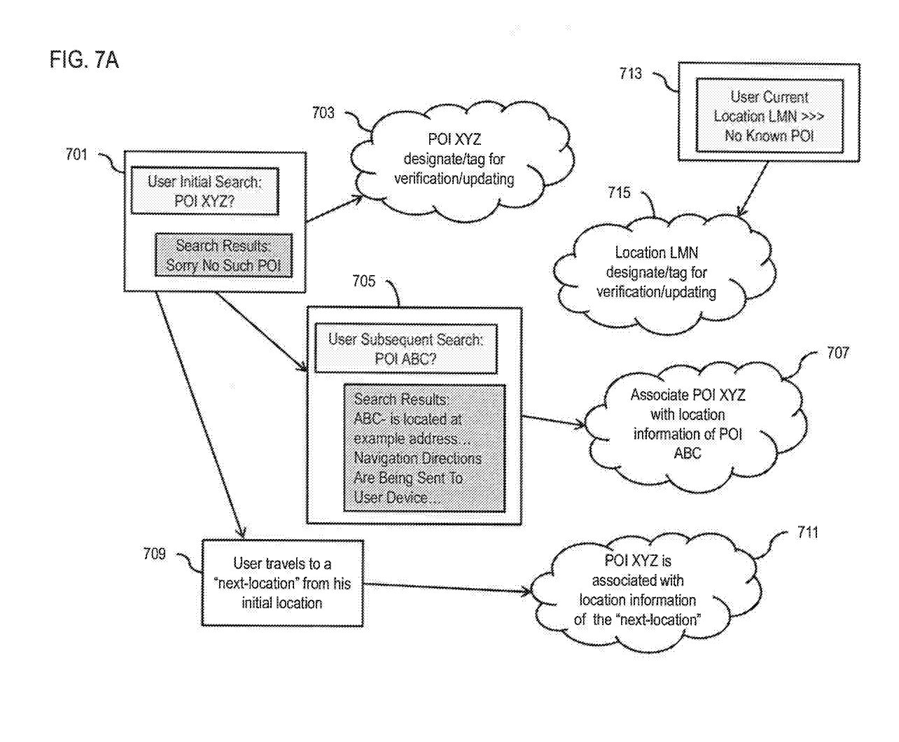

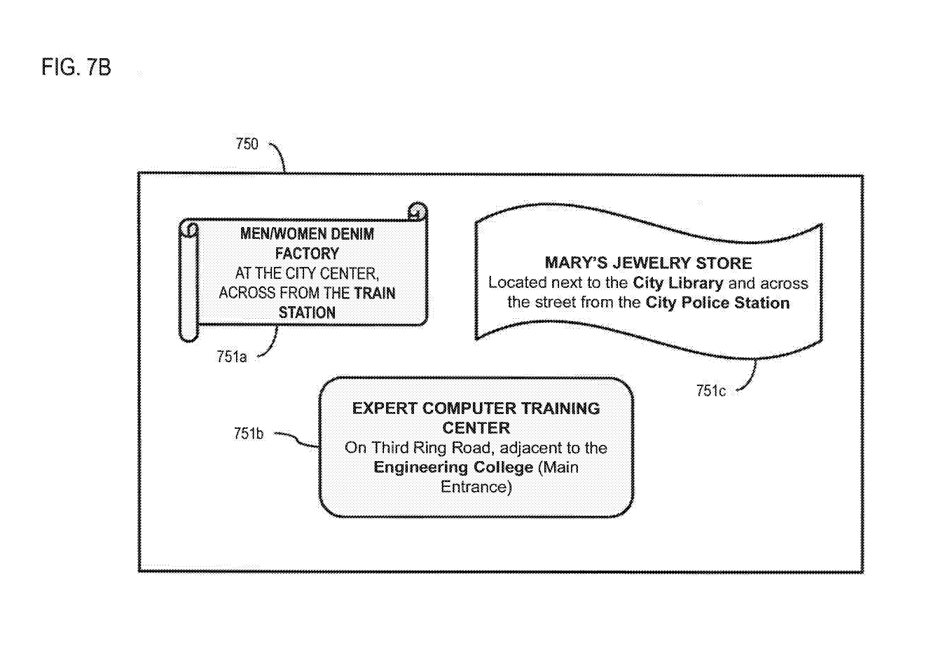

FIG. 7A illustrates flow diagrams of various scenarios for identifying information to be verified and updated, according to an embodiment. In the search query 701, a service provider may receive a search request from a user seeking location information for a POI “XYZ,” where in one instance, if the service provider is not be able to find the information, it would return a message to notify the user of the “unknown” POI. In one embodiment, the service provider may submit the “unknown” POI, at 703, to the updating platform 113 so the “unknown” POI may be designated/tagged for verification and updating. In one embodiment, the service provider may find and present unverified or erroneous information on the POI “XYZ,” which also may be submitted to the updating platform 113 for verification and updating. In one scenario, the user in 705 may choose to submit a subsequent search request for information on a POI “ABC” and if the service provider presents valid search result, then at 707 the location information of the POI-ABC may be associated with the POI-XYZ for verification and updating by the updating platform 113. The service provider may suggest the association based on a most likely probability that once the user did not receive the desired information on the initial POI-XYZ, then the user's subsequent search for location information of the subsequent POI-ABC (e.g., a landmark) potentially was related to the location information of the POI-XYZ. In one scenario, the user at 709 may determine potential location information for the POI-XYZ (e.g., from other sources) and travel to a next location. In one embodiment, the service provider may determine that next-location information and designate that next-location for verification, associating, and updating the POI-XYZ location information to that next-location information. In one embodiment, a service provider at 713 may determine from location information of UEs 101 that a plurality of the UEs 101 have gathered at a certain location “LMN”. Further, the service provider may compare that LMN gathering location with one or more POI databases and try to determine if that LMN location may be near one or more known or verified POIs. If there are no POIs associated with the LMN location, then at 715 that LMN location may be designated for identification, verification, and updating in one or more databases. In one scenario, the location LMN location may that of a new POI which is not yet updated in the databases.

FIG. 7B illustrates presentations of location information of various points of interest. In various regions it may customary or sometimes necessary to provide location information for a particular POI with reference to location information of one or more known POIs and/or landmarks. For example, in the samples shown in collection 750 location information of the POIs 751a-751c are provided with reference to other POIs and landmarks, where a user may either be familiar with and can easily navigate there, or a user may use a known POI/landmark in a search, obtain its location information, and then navigate to that location, which would be substantially close to the target POI. For example, in the 751b example, if a user wishes to find location information for the “Expert Computer Training Center,” either the user may know where the “Engineering College” is or he may use the “Engineering College” as a POI in a query and find its location information.

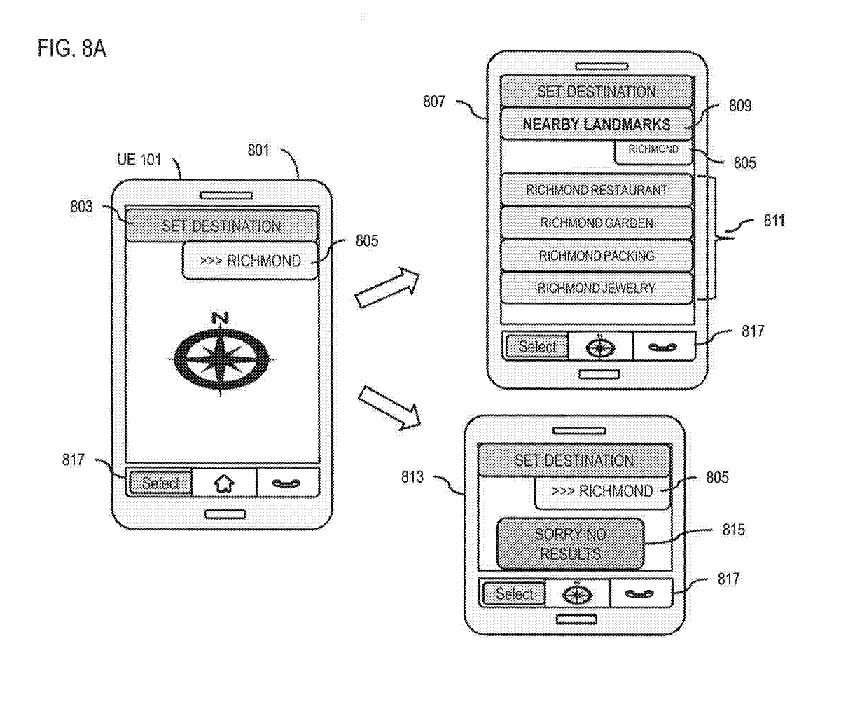

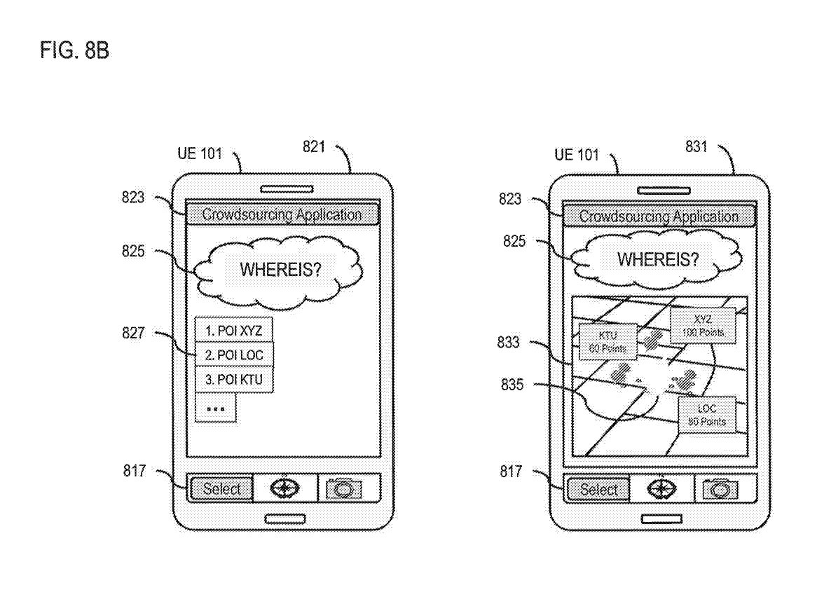

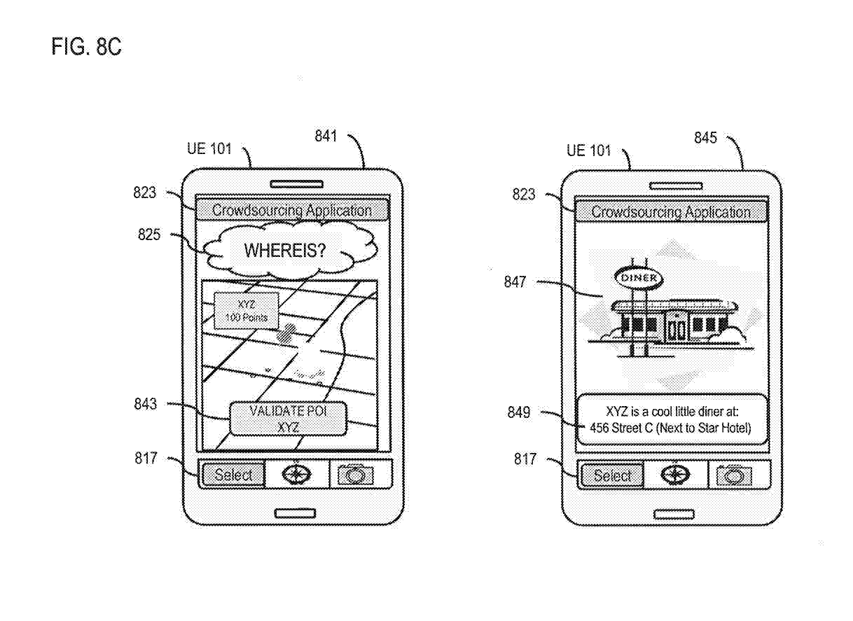

FIGS. 8A through 8C are diagrams of user interfaces utilized in the processes of FIGS. 4-6 and 7A, according to various embodiments.

FIG. 8A includes UI 801 at a UE 101 where a user may utilize a navigation application 803 to request location information on a POI 805 “RICHMOND”. In one embodiment, at UI 807, a service provider may present an option 809 for searching for the POI RICHMOND by searching for nearby landmarks, which may also include a reference to RICHMOND. In one example, the search results 811 may present one or more POIs which include a reference to RICHMOND. In one embodiment, at 813, the user may choose to conduct the search based on the POI RICHMOND, where the service provider may return a message 815 indicating no such POI. In various embodiments, a use may interface with the UE 101 via one or more user interface features 817, which may include mechanical or touch-sensitive options.

FIG. 8B includes UI 821 at the UE 101 where a crowdsourcing application 823 may be utilized to present an interactive application 825, for example WHEREIS? For determining one or more POIs 827 which may need to be verified and updated in one or more databases. In one example, the updating platform 113 may cause the launching of the application 825 at the UE 101 and present the POI list 827 to a user at the UE 101. In one embodiment, a user at the UE 101 may locally launch the application 825, whereby the POI list 827 may be retrieved from the updating platform 113. In various embodiments, a user at the UE 101 or an application 103 at the UE 101 may determine one or more information items, for example, location information, associated with a POI and submit the information to the updating platform 1134 verification and updating. Further, in UI 831 at the UE 101 may present the POI list 827 on a map application 833, wherein the POIs may be presented as location points on the map. In one embodiment, the location information of the one or more POIs may be presented with reference to a current location 835 of the user device UE 101. In one embodiment, the service providers 105, content providers 107, or the updating platform 113 may provide various points or credits for providing verification and updating information associated with the POIs 827. For example, the map application 833 indicates various points associated with each POI that a user/device may receive for providing information associated with each POI, where the points may be credited to a user account or saved at the UE 101 for future use for product purchases, services, or online activities.

FIG. 8C includes UI 841 at a UE 101 where a user may select a POI and provide various information items for validating the POI. In one example, a user at the UI 841 has selected the POI XYZ for validation via one or more UI interactions 843 or 817. In one example, the user may be presented with 100 points for providing validation information, wherein the points may be presented/credited by a service provider or the updating platform 113 after the POI information submitted by the user is verified. In one embodiment, the user by selecting the validation interface 843 or 817 may cause various information items to be collected by one or more sensors at the UE 101 and submitted substantially automatically as part of the information provided to the service provider or the updating platform 113. In one embodiment, at UI 845, a user may provide one or more images 847 and additional information 8494 verification an Association with the POI that is to be validated, e.g., POI XYZ.

The processes described herein for a mechanism for updating or validating information associated with potential points of interest using crowd sourcing methods may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

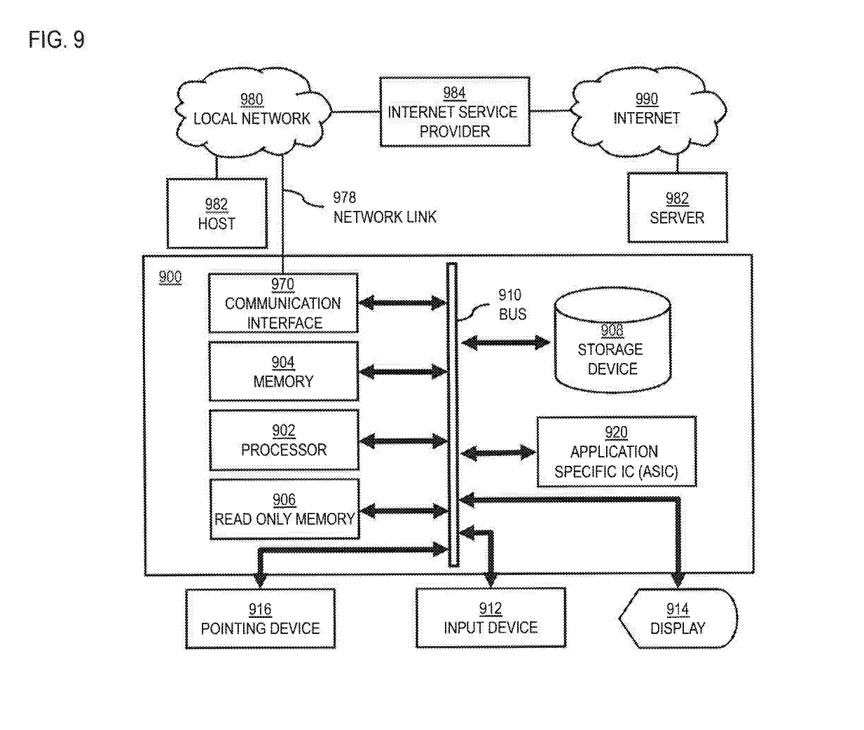

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) for updating or validating information associated with potential points of interest using crowd sourcing methods as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps for updating or validating information associated with potential points of interest using crowd sourcing methods.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to updating or validating information associated with potential points of interest using crowd sourcing methods. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for updating or validating information associated with potential points of interest using crowd sourcing methods. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for updating or validating information associated with potential points of interest using crowd sourcing methods, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914, and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 111 for updating or validating information associated with potential points of interest using crowd sourcing methods.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980, and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed for updating or validating information associated with potential points of interest using crowd sourcing methods as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps for updating or validating information associated with potential points of interest using crowd sourcing methods.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein for updating or validating information associated with potential points of interest using crowd sourcing methods. The memory 1005 also stores the data associated with or generated by the execution of the inventive steps.

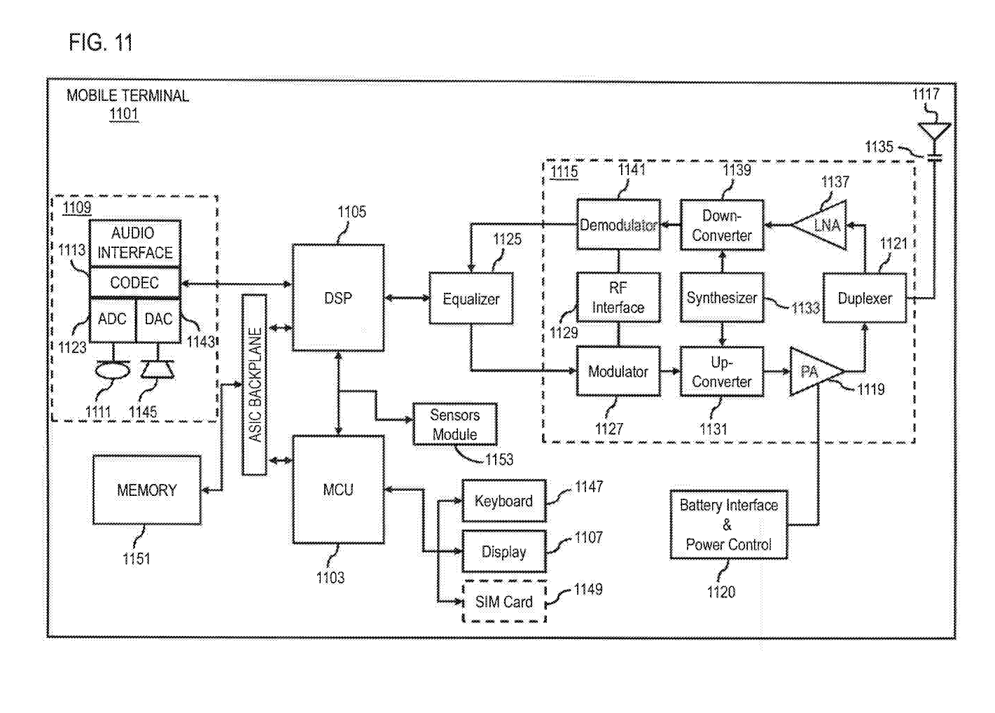

FIG. 11 is a diagram of exemplary components of a mobile terminal (e.g., handset) for communications, which is capable of operating in the system of FIG. 1, according to an embodiment. In some embodiments, mobile terminal 1101, or a portion thereof, constitutes a means for performing one or more steps for updating or validating information associated with potential points of interest using crowd sourcing methods. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps for updating or validating information associated with potential points of interest using crowd sourcing methods. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 for updating or validating information associated with potential points of interest using crowd sourcing methods. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-28. (canceled)

29. A method comprising:
determining at least one query from at least one device for location information associated with at least one point of interest;
determining at least one next location visited by the at least one device; and
causing, at least in part, an updating of the location information associated with the at least one point of interest based, at least in part, on the at least one next location.

30. A method of claim 29, further comprising:
determining at least another query from the at least one device for other location information associated with at least one other point of interest,
wherein the updating of the location information associated with the at least one point of interest is based, at least in part, on the other location information.

31. A method of claim 30, further comprising:
determining a distribution of the at least one query relative to (a) the at least one next location, (b) the other location information, or (c) a combination thereof,
wherein the updating of the location information is based, at least in part, on (a) the distribution, (b) a frequency of occurrence of the at least one next location, the other location information, or a combination thereof in the distribution, or (c) a combination thereof.

32. A method of claim 29, further comprising:
causing, at least in part, an initiation of the determination of the at least one next location, the updating of the location information, or a combination thereof based, at least in part, on a determination that the at least one query produces at least one null result, at least one invalid result, or a combination thereof.

33. A method of claim 29, further comprising:
causing, at least in part, a designation of the updating of the location information for the at least one point of interest as one or more unverified updates.

34. A method of claim 33, further comprising:
determining the one or more unverified updates, one or more potential points of interest, or a combination thereof based, at least in part, on a monitoring of one or more locations at which the one or more verifying devices aggregate.

35. A method of claim 33, further comprising:
causing, at least in part, a prioritization of the one or more unverified updates based, at least in part, on a frequency of queries for the at least one point of interest associated with the one or more unverified updates.

36. A method of claim 35, further comprising:
causing, at least in part, a submission of the one or more unverified updates for a crowd-sourced verification to one or more verifying devices; and
causing, at least in part, one or more updates to the one or more unverified updates based, at least in part, on contextual information associated with the at least one point of interest received from the one or more verifying devices.

37. A method of claim 36, further comprising:
determining the one or more verifying devices based, at least in part, on a proximity of the one or more verifying devices to the at least one point of interest associated with the one or more unverified updates.

38. A method of claim 36, wherein the submission of the one or more unverified updates for the crowd-sourced verification is based, at least in part, on the prioritization of the one or more unverified updates.

39. An apparatus comprising:
at least one processor; and
at least one memory including computer program code for one or more programs,
the at least one memory and the computer program code configured to, with the at least one processor, cause the apparatus to perform at least the following,
determine at least one query from at least one device for location information associated with at least one point of interest;
determine at least one next location visited by the at least one device; and
cause, at least in part, an updating of the location information associated with the at least one point of interest based, at least in part, on the at least one next location.

40. An apparatus of claim 39, wherein the apparatus is further caused to:
determine at least another query from the at least one device for other location information associated with at least one other point of interest,
wherein the updating of the location information associated with the at least one point of interest is based, at least in part, on the other location information.

41. An apparatus of claim 40, wherein the apparatus is further caused to:
determine a distribution of the at least one query relative to (a) the at least one next location, (b) the other location information, or (c) a combination thereof,
wherein the updating of the location information is based, at least in part, on (a) the distribution, (b) a frequency of occurrence of the at least one next location, the other location information, or a combination thereof in the distribution, or (c) a combination thereof.

42. An apparatus of claim 39, wherein the apparatus is further caused to:
cause, at least in part, an initiation of the determination of the at least one next location, the updating of the location information, or a combination thereof based, at least in part, on a determination that the at least one query produces at least one null result, at least one invalid result, or a combination thereof.

43. An apparatus of claim 39, wherein the apparatus is further caused to:
cause, at least in part, a designation of the updating of the location information for the at least one point of interest as one or more unverified updates.

44. An apparatus of claim 43, wherein the apparatus is further caused to:
determine the one or more unverified updates, one or more potential points of interest, or a combination thereof based, at least in part, on a monitoring of one or more locations at which the one or more verifying devices aggregate.

45. An apparatus of claim 43, wherein the apparatus is further caused to:
cause, at least in part, a prioritization of the one or more unverified updates based, at least in part, on a frequency of queries for the at least one point of interest associated with the one or more unverified updates.

46. An apparatus of claim 45, wherein the apparatus is further caused to:
cause, at least in part, a submission of the one or more unverified updates for a crowd-sourced verification to one or more verifying devices; and
cause, at least in part, one or more updates to the one or more unverified updates based, at least in part, on contextual information associated with the at least one point of interest received from the one or more verifying devices.

47. An apparatus of claim 46, wherein the apparatus is further caused to:
determine the one or more verifying devices based, at least in part, on a proximity of the one or more verifying devices to the at least one point of interest associated with the one or more unverified updates.

48. An apparatus of claim 46, wherein the submission of the one or more unverified updates for the crowd-sourced verification is based, at least in part, on the prioritization of the one or more unverified updates.
